(19) United States
(12) Patent Application Publication
(10) Pub. No.: US 2024/0099504 A1
(43) Pub. Date: Mar. 28, 2024

(54) Apparatus and Method for Heat-Retention Cooking

(71) Applicant: Michael James PILON, Reston, VA (US)

(72) Inventor: Michael James PILON, Reston, VA (US)

(21) Appl. No.: 18/373,912

(22) Filed: Sep. 27, 2023

Related U.S. Application Data
(60) Provisional application No. 63/474,871, filed on Sep. 28, 2022.

(51) Int. Cl. A47J 36/06

(52) U.S. Cl. CPC A47J 36/06

(57) ABSTRACT

Various aspects include devices, systems, and methods for heat-retention cooking with a heat-retention cooker including a lid, rider rod, and an upper heat-retaining member. The lid is configured to sit on top of a lower heat-retaining member such that a lower rim of the lid is configured to engage an upper surface of the lower heat-retaining member and together the lid and the lower heat-retaining member are configured to form a cooking chamber there between. The lid and the lower heat-retaining member block substantially all airflow into the cooking chamber. The riser rod extends through a top of the lid into the cooking chamber. A position of the riser rod relative to the lid is adjustable between at least a lower position and a higher position. Movement of the riser rod raises or lowers the upper heat-retaining member.

### RELATED APPLICATIONS

This application claims the benefit of priority to U.S. Provisional Patent Application No. 63/474,871 entitled “Apparatus and Method for Baking Pizza or Other Foods at Hight Temperature Using Stored Heat,” filed Sep. 28, 2022, the entire contents of which are hereby incorporated by reference for all purposes.

### BACKGROUND

It is common knowledge within the pizza making community that a pizza baked quickly at a high temperature creates a crust that is puffy at the edges, crispy and pleasantly charred on the outside yet light, soft, and airy on the interior that provides a desirable texture and flavor. This classic baking style is indicative of the famous Neapolitan Pizza baked throughout Italy and with an ever-increasing frequency in United States' pizzerias and restaurants. While there is not a formal definition for artisan pizzas, it usually suggests handmade pizzas made with the highest quality ingredients using a variety of traditional and gourmet pizza toppings baked quickly at high temperatures. Traditionally, these high baking temperatures are achieved through large brick ovens fueled by wood, coal and/or natural gas.

Large masonry ovens (both indoor and outdoor) made from brick, stone, ceramic and/or clay fueled by coal, gas and/or wood are commonly used to cook pizzas at high temperatures. In addition, large metal insulated ovens with “stone” decks are often used in commercial establishments. Stone decks are commonly made from FibraMent, a proprietary blend of NSF-approved kiln-fired materials; Rokite; synthetic cordierite, a mineral used to make ceramics; and other fired-clay products.

Recently many other baking apparatuses for home use have been brought to market to increase pizza baking temperatures above what may typically be achieved in a traditional kitchen oven (often the highest temperature setting of a gas or electric oven is 550F). These baking apparatuses usually include metal enclosures that trap direct heat produced from natural gas, wood, or wood pellets; metal enclosures that fit onto gas or charcoal grills to control and consolidate heat from active heat sources; or electric devices that use heat from electrical coils that bake pizzas from both the top and the bottom.

### SUMMARY

Various aspects include devices, systems, and methods for cooking with a heat-retention cooker including a lid, rider rod, and an upper heat-retaining member. The lid is configured to sit on top of a lower heat-retaining member that is detached from the lid such that a lower rim of the lid is configured to engage an upper surface of the lower heat-retaining member and together the lid and the lower heat-retaining member are configured to form a cooking chamber there between for containing and cooking food placed on the lower heat-retaining member and under the lid. The lid and the lower heat-retaining member block substantially all airflow into the cooking chamber from under the lid. The riser rod extends through a top of the lid into the cooking chamber, wherein a position of the riser rod relative to the lid is adjustable between at least a lower position and a higher position. The upper heat-retaining member fixedly secures to the riser rod, wherein movement of the riser rod raises or lowers the upper heat-retaining member.

In some aspects the heat-retention cooker may further include at least one thermal barrier plate disposed inside the cooking chamber between a top of the lid and the upper heat-retaining member, wherein the riser rod extends through an opening in the at least one thermal barrier plate. The upper heat-retaining member may have material characteristics such that, in cooperation with the lower heat-retaining member and the lid, the upper heat-retaining member is configured to retain heat sufficient to maintain the cooking chamber above 400 degrees Fahrenheit for more than 10 minutes after all heat sources heating the upper and lower heat-retaining members have been removed. The lid may be a substantially semi-spherical shape or dome shape. An upper region on the inside of the lid may include a contoured shaped configured to receive the upper heat-retaining member when the riser rod is in the higher position.

In some aspects the heat-retention cooker may further include a locking mechanism for selectively holding the riser rod in at least one of the lower position, the higher position, or a position there between. The locking mechanism may include at least one of a cotter pin, a tension spring, a spring-loaded pin latch, or a ball point spring plunger. The locking mechanism may automatically secure the upper heat-retaining member in an upper position in response to the riser rod being raised toward the higher position.

In some aspects the lower heat-retaining member is part of the heat-retention cooker.

Various aspects include a method of using a heat-retention cooker. The method may include removing a lower heat-retaining member from heat supplied by at least one heat source. Food intended to be cooked may be placed on the lower heat-retaining member removed from the heat supplied by the at least one heat source. An upper heat-retaining member, separate from the lower heat-retaining member, may be removed from heat supplied by the at least one heat source, wherein the upper heat-retaining member is fixedly secured to a riser rod extending through a top of a lid. The lid, containing the upper heat-retaining member that was removed from the heat supplied by the at least one heat source, may be seated on the lower heat-retaining member such that a lower rim of the lid engages an upper surface of the lower heat-retaining member and together the lid and the lower heat-retaining member form a cooking chamber there between that contains food placed on the lower heat-retaining member. The upper heat-retaining member may be removed from the lower heat-retaining member for removing the food after a cooking period of the food.

In some aspects, the riser rod may be raised above the lid to lift the upper heat-retaining member before seating the upper heat-retaining member on the lower heat-retaining member. A position of the riser rod relative to the lid may be adjustable between at least a lower position and a higher position, wherein movement of the riser rod raises or lowers the upper heat-retaining member, wherein the heat supplied by the at least one heat source heats the upper heat-retaining member in the lower position. The at least one heat source may include at least a first heat source separate from a second heat source, wherein the heating of the lower heat-retaining member is done by the first heat source and the heating of the upper heat-retaining member is done by the second heat source. The lid and the lower heat-retaining member may block substantially all airflow into the cooking chamber from under the lid.

### BRIEF DESCRIPTION OF THE DRAWINGS

The accompanying drawings, which are incorporated herein and constitute part of this specification, illustrate exemplary embodiments of the claims and together with the general description given above and the detailed description given below, serve to explain the features of the claims.

FIG. 1A is a cross-sectional view of a heat-retention cooker in accordance with various embodiments.

FIG. 1B is cross-sectional view of the heat-retention cooker from FIG. 1A with the lid separated from the lower heat-retaining member, both being heated, in accordance with various embodiments.

FIG. 1C is cross-sectional view of the heat-retention cooker from FIGS. 1A and 1B with the lid sitting on the lower heat-retaining member and with the upper heat-retaining member in a raised position in accordance with various embodiments.

FIG. 2 is a cross-sectional view of a heat-retention cooker sitting on an alternative lower heat-retaining member in accordance with various embodiments.

FIG. 3 is a cross-sectional view of an alternative heat-retention cooker with a contoured lid in accordance with various embodiments.

FIGS. 4A-4B are process flow diagrams illustrating methods of using a robot for maneuvering through viscous mixtures in accordance with various embodiments.

FIG. 5 is a table of data illustrating a heat retention analysis of the heat-retention cooker in accordance with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include a heat-retention cooker, such as one used as a portable pizza cooker, which may include a lid, riser rod, and an upper heat-retaining member, any or all of which may be made from a durable heat-resistant material. The lid may be a domed-shaped cover from a high thermal conductivity material such as stainless steel, ceramic, or a high-grade alloy. The interior surface may be coated with a heat-reflective material for enhanced heat distribution. The lid may be shaped to sit securely atop a separate lower heat-retaining component. The peripheral lower rim of the lid may be shaped to make contact with the upper surface of this lower heat-retaining component, thereby creating an isolated cooking chamber (or cooking space). The cooking chamber/space may be suitable for holding and cooking food positioned on the lower component and beneath the lid. The lid and/or the lower component may effectively prevent almost all airflow into the cooking space.

The riser rod may be a cylindrical rod made of a durable heat-resistant material that serves as an attachment point for the upper heat-retaining member and/or allows for the vertical positioning of the upper heat-retaining member within the cooking chamber. The riser rod may pass through an aperture centrally located at the apex of the lid (through the top of the lid and reach into the cooking chamber). The rod may be vertically adjustable and may be positioned at various heights relative to the lid by means of a locking mechanism, such as a set screw or quick-release clamp. The placement of the riser rod may be adjusted in relation to the lid, moving between a minimum (lower) position and a maximum (higher) position. The upper heat-retaining member may be firmly attached to the riser rod. As the riser rod moves, it may elevate (raise) or descend (lower) the upper heat-retaining member.

The upper heat-retaining member may be a flat or slightly curved disk made from a high thermal mass material, such as cast iron, ceramic, or a composite material designed for heat retention. The upper heat-retaining member may be affixed securely to the lower end of the riser rod by means of screws, clamps, or a similar fastening technique or mechanism. The upper heat-retaining member may serve as an auxiliary heat source and may be pre-heated prior to use. The placement of the upper heat-retaining member within the cooking chamber may be adjustable via the riser rod, allowing for customizable heat distribution (e.g., depending on the food being cooked, style of pizza, etc.).

In operation, both the upper heat-retaining member and the separate lower heat-retaining component may be preheated using an external heat source. Once the desired temperature is reached, the food to be cooked may be placed on the lower heat-retaining component, the upper heat-retaining member may be positioned above the food by adjusting the riser rod, and the lid may be placed over the lower heat-retaining component to enclose the food in a heat-efficient cooking chamber. Within the cooking chamber, the food may be cooked evenly from both above and below due to the heat emanating from the upper and lower heat-retaining members.

In some embodiments, a user may heat the heat-retaining member in a lowered position, on a stove, fire, or other heat source. In some embodiments, the heat-retaining member may be heated to achieve temperatures in the range of 600° F. to 1120° F. Separately, the user may heat the lower heat-retaining member. The lower heat-retaining member may be heated on a separate heat source or a separate part of the same heat source (e.g., different parts of a campfire). In some embodiments, the lower heat-retaining member may be heated to achieve temperatures in the range of 350° F. to 600° F. Once both the upper and lower heat-retaining members are heated high enough, food that is intended to be cooked, such as an uncooked pizza, may be placed on the heated lower heat-retaining member. Also, the upper heat-retaining member may be raised inside the lid before moving the lid, with the raised upper heat-retaining member, to cover the food on the lower heat-retaining member. Preferably, the food intended to be cooked may be placed centrally on the lower heat-retaining member or at least located on the lower heat-retaining member in a way that the lid can cover the food without the lid touching the food. Placing the lid on the lower heat-retaining member may enclose the food within a cooking chamber under the lid and on top of the lower heat-retaining member. Inside the cooking chamber, the food will sit between the upper and lower heat-retaining members. Due to the high heat stored in the upper and lower heat-retaining members before loading the food, the food contained within the cooking chamber will be cooked within minutes.

In some embodiments, the user may have the option to preheat the upper heat-retaining member in its lowered state, employing a heat source such as a stove, fire, or alternative heating medium. The upper heat-retaining member may achieve temperature ranges between 600° F. and 1120° F. Optionally, the user may concurrently heat the lower heat-retaining member to also reach temperature ranges from 600° F. to 1120° F. The lower heat-retaining member may be heated on a distinct heat source or on a separate section of the existing heat source. Also, the lower heat-retaining member need not be heated to the same temperature as the upper heat-retaining member. Once both the upper and lower heat-retaining members have reached sufficient temperatures, the food intended for cooking (e.g., an unbaked pizza, etc.) may be placed upon the heated lower heat-retaining member. In addition, the upper heat-retaining member may be elevated within the lid prior to shifting the lid to encapsulate the food situated on the lower heat-retaining member. The food may be situated centrally on the lower heat-retaining member (or positioned in a manner that allows the lid to encapsulate the food without making contact) so that food is enclosed within a cooking chamber (formed between the lid and the lower heat-retaining member). The food may be placed between the preheated upper and lower heat-retaining members inside the cooking chamber. The retained high temperatures in both the upper and lower heat-retaining members may allow the food inside the cooking chamber to be cooked in a matter of minutes.

In some embodiments, the upper and lower heat-retaining members may be crafted from a composite of high-grade stainless steel and ceramic coatings. Stainless steel may offer robust structural integrity and the ceramic coatings may enhance thermal insulation and resistance. In some embodiments, the upper and lower heat-retaining members may have a thickness ranging from 3 to 6 millimeters (i.e., ˜0.118 to 0.236 inches). The thickness may range from about 3.2 to about 5.8 mm, about 3.4 to about 5.6 mm, about 3.6 to about 5.4 mm, about 3.8 to about 5.2 mm, about 4.0 to about 5.0 mm, including all ranges and subranges therebetween using any of the foregoing as upper or lower limits, relative to the total thickness. The upper and lower heat-retaining members need not be the same thickness. The synergistic combination of these materials and their respective thicknesses may allow the heat-retaining members to achieve and sustain temperature ranges from 600° F. to 1120° F. This temperature range is often sufficient for rapid and even cooking. In some embodiments, the materials and their corresponding thicknesses may be selected to enhance heat retention and/or improve to the overall durability and longevity of the heat-retaining members.

In some embodiments, the upper and lower heat-retaining members may be crafted from other materials and/or include other thicknesses to achieve similar functionalities as the original design. For example, in some embodiments, the upper and lower heat-retaining members may be crafted from cast iron or aluminum. Cast iron is known for its excellent heat retention and distribution. Aluminum is lighter and offers exceptionally good thermal conductivity properties. If stainless steel were replaced with cast iron, which generally retains heat better, the thickness could possibly be reduced to achieve similar heat retention capabilities.

Heat-retention cooking, also known as retained-heat cooking, is a method of using trapped heat to continue cooking food without additional fuel or energy. After bringing the food to the desired cooking temperature using conventional means, the pot or vessel containing the food is then insulated to prevent heat loss. As a result, the food continues to cook, benefiting from the retained heat. Conventional heat-retention cooking uses heat stored in the cooking vessel but continues cooking while continuing to actively heat the cooking vessel. In contrast, various embodiments herein do not need to use active heating of the lid, upper heat-retention member, or even the lower heat-retention member. Although active heating of one or more of these elements during the cooking phase may be done, if desired, such active heating is not needed for the principle of operation of the heat-retention cooker according to various embodiments.

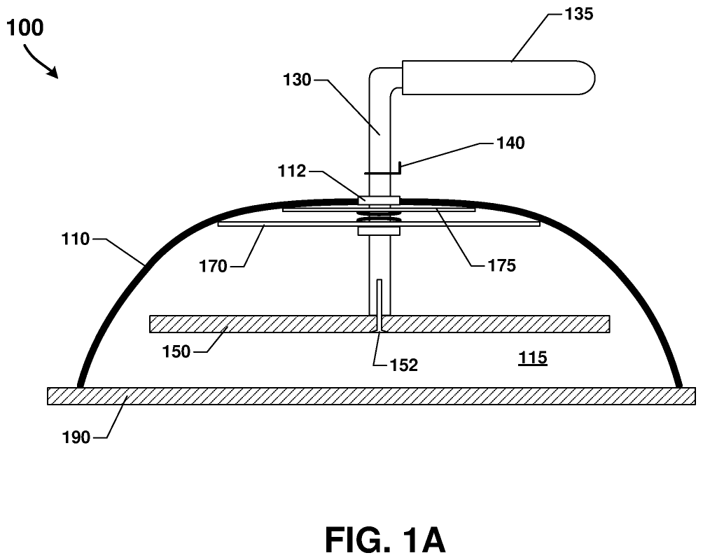

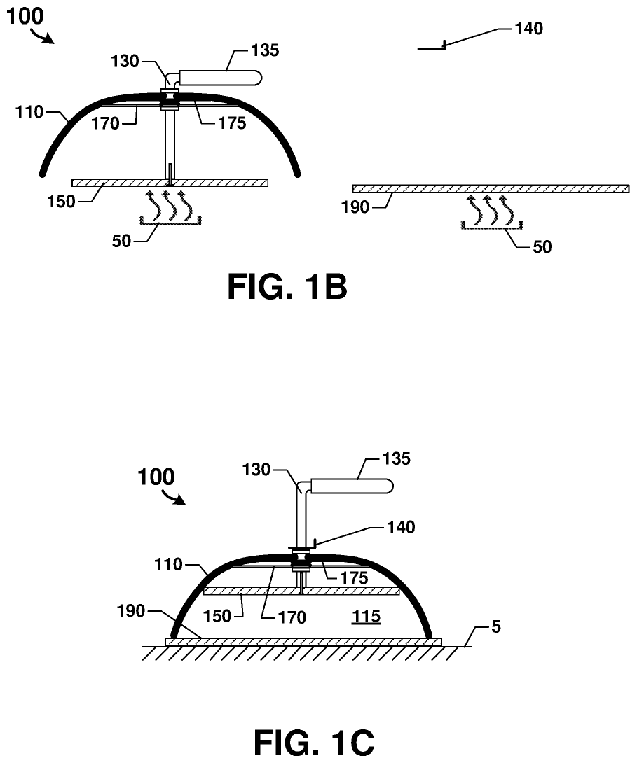

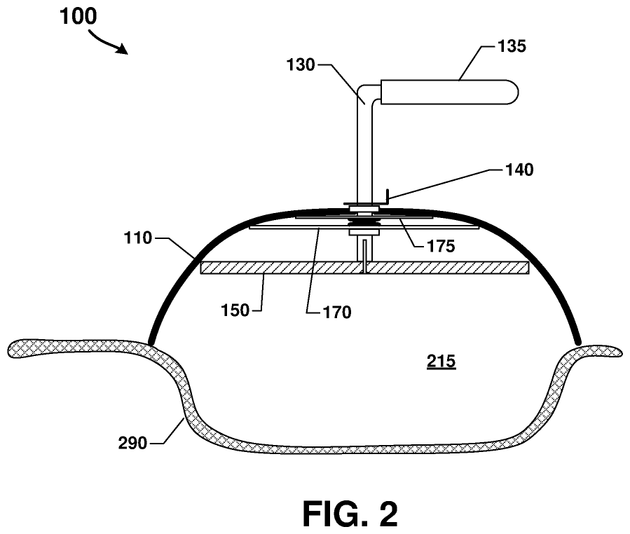

FIG. 1A illustrates a heat-retention cooker 100, positioned atop or sitting on top of a lower heat-retaining member 190, in accordance with various embodiments. The heat-retention cooker 100 includes a lid 110, a riser rod 130, and an upper heat-retaining member 150. The riser rod 130 extends through an aperture in a top of the lid 110 into the cooking chamber 115. The riser rod 130 is configured to slide up or down (in the configuration shown in FIG. 1A) relative to the lid 110. Also, the upper heat-retaining member 150 is fixedly secured to the riser rod 130. Thus, the up or down movement of the riser rod 130 in-turn raises or lowers the upper heat-retaining member 150.

The lid 110 is configured to sit on top of the lower heat-retaining member 190 such that a lower rim of the lid 110 is configured to engage an upper surface of the lower heat-retaining member 190. Together the lid 110 and the lower heat-retaining member 190 are configured to form a cooking chamber 115 in which food may be cooked. In this way, the lower heat-retaining member 190 should be larger than an area covered by the lower rim of the lid 110. The lower heat-retaining member 190 may be a metal or ceramic plate. Although the lid 110 may be placed on top of the lower heat-retaining member 190, since the lid 110 is detached from the lower heat-retaining member 190, the lid 110 may be removed at any time. Together, the lid 110 and the lower heat-retaining member 190 will block substantially all airflow into or out of the cooking chamber. In various embodiments, the lid 110 is a substantially semi-spherical shape.

The phrase “wherein the lid and the lower heat-retaining member block substantially all airflow into the cooking chamber from under the lid,” as used herein describes a design feature where the lid 110 and the lower heat-retaining member 190 work together to prevent or significantly reduce the entry of air into a designated space, known as the cooking chamber, specifically from the direction beneath the lid. The aim behind this design is to ensure a controlled environment inside the cooking chamber 115, which is vital for certain cooking applications, where airflow can impact temperature, moisture, and the overall cooking process. The term “substantially all” suggests that while not 100% of the airflow is blocked, a vast majority is, possibly ranging from 90% to 99.9%, though the exact percentage might vary. The effective blocking of airflow may be achieved through a precision alignment, flat edges, or the use of heavy materials to ensure any potential gaps or spaces are securely closed. Overall, this feature emphasizes creating an almost airtight environment in the cooking chamber for consistent cooking conditions.

The term “substantially semi-spherical shape” refers to a shape that closely resembles half of a sphere or a dome. The term “substantially” as used herein means that the shape, size, or other characteristic being described, does not have to be exact (e.g., not a perfect half-sphere for a dome-shape) but is very close to it, allowing for minor deviations or imperfections. In terms of a shape, this could mean that the shape might have slight flat spots, minor bulges, or other small irregularities, but the general form should be easily identifiable as being derived from a sphere cut in half.

The aperture in the lid 110 through which the riser rod 130 extends may include a bushing 112, bearing, or other fitting to enable a smooth sliding movement of the riser rod 130 relative to the lid 110 to be adjustable between at least a lower position and a higher position. The riser rod 130 may include a handle 135 configured to enable a user to adjust the height of the riser rod 130 relative to the lid 110.

The heat-retention cooker 100 may also include a locking mechanism 140 for selectively holding the riser rod 130 in at least one of the lower position, the higher position, or a position there between. In the embodiment shown, the locking mechanism 140 is a pin configured to be inserted through one or more slots in a vertical shaft of the riser rod 130. The weight of the upper heat-retaining member 150 will bias the riser rod 130 toward the lower position, so the locking mechanism 140 may limit such downward movement once the locking mechanism reaches the top of the lid 110 or the bushing 112. The riser rod 130 may include a slot or lateral aperture configured to receive the pin to form the locking mechanism. In addition, the riser rod 130 may include a series of vertically spaced slots or lateral apertures enabling the riser rod 130 position to be limited from different positions. In this way, the lower heat-retaining member 190 may be held in, for example, a lower position, a mid-height position, and/or an upper position.

The locking mechanism 140 may be in the form of a cotter pin, which is commonly used to secure two parts together, especially in mechanical assemblies. A cotter pin is a split pin that is inserted through a hole and bent to keep it in place. Another securing mechanism is a tension spring, which is an elastic coil designed to exert a force between two points when pulled apart and to retract when released. A spring-loaded pin latch operates by applying pressure to a pin, which then extends to lock into a receiving hole or slot, only retracting when the spring mechanism is actuated. Similarly, a ball point spring plunger consists of a spring-driven ball that protrudes from its housing, which can be depressed to fit into a hole or groove and then released to exert outward pressure, holding components together. Each of these mechanisms offers different advantages based on the specific application and design requirements.

The locking mechanism 140 may automatically secure the upper heat-retaining member 150 in an upper position in response to the riser rod 130 being raised toward the highest position. The riser rod 130 may be designed with a series of equally spaced notches or indentations along its length. Surrounding the riser rod 130 may be a collar (e.g., above bushing 112), which is affixed with an internal spring-loaded pin or ball detent. As the riser rod 130 is adjusted vertically, the spring-loaded pin or ball detent is pushed inwards, sliding over the surface of the riser rod 130. When the desired position is reached, the pin or ball detent engages one of the notches, locking the riser rod 130 securely in place. This mechanism ensures a secure fit while allowing for easy adjustments. To change the vertical position, the user would apply an external force to disengage the pin or ball detent from its notch, move the riser rod 130 to the desired position, and then release to let the mechanism lock into the next appropriate notch.

The upper heat-retaining member 150 may have the form of a disk or circular metal plate, which is fixed to a bottom of the riser rod 130. The upper heat-retaining member 150 may have material characteristics such that, in cooperation with the lower heat-retaining member and the lid, the upper heat-retaining member is configured to retain heat sufficient to maintain the closed cooking chamber above 400 degrees Fahrenheit for more than 10 minutes after all heat sources heating the upper and lower heat-retaining members have been removed. For example, the upper and lower heat-retaining members 150, 190 may be constructed of a material with high thermal conductivity and heat capacity. The upper and lower heat-retaining members 150, 190 may be constructed of a variety of materials known for their high-temperature resilience and stability. Cast iron is a choice due to its outstanding heat retention and distribution capabilities. Stainless steel, especially high-grade variants, can also endure such elevated temperatures. Ceramics, particularly those designed for high-temperature applications, are another viable material, as they not only withstand but also effectively distribute heat. In the realm of non-metals, certain types of tempered glass, known as borosilicate glass, have a composition allowing them to handle extreme heat without breaking. Additionally, some advanced composite materials, designed specifically for high-temperature scenarios in industries like aerospace or automotive, can also be fashioned into plates capable of withstanding temperatures far beyond 400 degrees Fahrenheit. Each material has distinct properties, making it suitable for specific applications and conditions where high heat is a factor.

The thickness of the upper and/or lower heat-retaining members 150, 190 may play a crucial role in their heat retention ability: a thicker plate will have a greater mass, allowing it to store more thermal energy. The material's emissivity, or its ability to emit infrared energy, can also influence how it radiates heat into the cooking chamber. To maintain the closed cooking chamber above 400 degrees Fahrenheit for more than 10 minutes after the heat source is removed, the plate would ideally have a dense structure, be of sufficient mass and thickness, and possess a surface that distributes the heat evenly across its entirety. This ensures a consistent and prolonged release of stored heat into the chamber, thus achieving the desired cooking temperature duration.

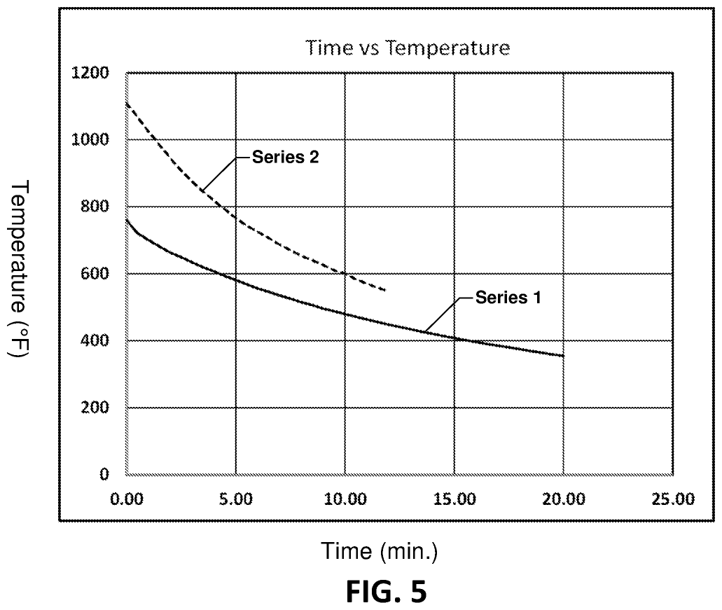

FIG. 5 shows a heat retention analysis of the heat-retention cooker comparing internal temperature over time, in accordance with various embodiments. As shown in FIG. 5, testing was performed using an upper heat-retaining member 150 and a lower heat-retaining member 190, each made of carbon steel and each having a thickness of 3/16^{TH} of an inch. Also, the lid used in this testing was a coated carbon steel of lesser thickness. A first test series (i.e., “Series 1”) heated the upper and lower heat-retaining members 150, 190. Once heated, all heat sources were removed, and the upper heat-retaining member 150 was seated on top of the lower heat-retaining member 190 and internal temperatures were regularly measured using a thermocouple placed inside the cooking chamber, with a starting internal temperature of 760° F. In order to achieve the starting internal temperature of 760° F., the upper heat-retaining member 150 was heated well above 760° F. Also, the upper heat-retaining member 150 was heated to a higher temperature than the lower heat-retaining member 190, to simulate a cooking environment in which food placed on the lower heat-retaining member 190 will burn too quickly when placed on an extremely hot surface. In Series 1, within 5 minutes the internal temperature dropped to approximately 581° F., and within 10 minutes the internal temperature dropped to approximately 480° F. In Series 1, the temperature eventually dropped below 400° F. just before the 16 minutes mark. Similarly, a second test series (i.e., “Series 2”) used the same setup, but heated the upper and lower heat-retaining members 150, 190 to a higher starting temperature. Once heated, all heat sources were removed, and the upper heat-retaining member 150 was seated on top of the lower heat-retaining member 190 and internal temperatures were regularly measured with a starting internal temperature of 1110° F. In Series 2, within 5 minutes the internal temperature dropped to approximately 766° F., and within 10 minutes the internal temperature dropped to approximately 600° F. In Series 2, at the 12 minute mark, the temperature was still at 547° F. Thus, this tested demonstrated that the tested upper heat-retaining member demonstrated material characteristics such that, in cooperation with the lower heat-retaining member and the lid, the upper heat-retaining member was and is configured to retain heat sufficient to maintain the closed cooking chamber above 400 degrees Fahrenheit for more than 10 minutes after all heat sources heating the upper and lower heat-retaining members have been removed.

The upper heat-retaining member 150 may be secured to the riser rod 130 in various ways. In some embodiments, a recessed securing bolt 152 holds the upper heat-retaining member 150 against the riser rod 130 from the bottom, while maintaining a flat lower profile of the upper heat-retaining member 150. In this way, a lower-most surface of the securing bolt 152 is flush with or at least does not protrude below the lower surface of the upper heat-retaining member 150. By not protruding below a lower surface of the upper heat-retaining member 150, the upper heat-retaining member 150 can rest flat and evenly on a heating element or other heat source for being fed heat during a heat-loading phase.

The heat-retention cooker 100 may additionally include at least one thermal barrier plate 170, 175 disposed inside the cooking chamber 115 between a top of an inside of the lid 110 and the upper heat-retaining member 150. The riser rod 130 may extend through a hole in the at least one thermal barrier plate 170, 175. The thermal barrier plates 170, 175 may be included to keep heat radiating downward toward the upper and lower heat-retaining members 150, 190. Additionally, the thermal barrier plates 170, 175 may provide insulation in the uppermost regions of the lid 110. The two thermal barrier plates 170, 175 may be spaced apart, leaving an air-break between them, which may act as an insulator. A spacer may be used to maintain the desired spacing between the thermal barrier plates 170, 175. For example, FIG. 1A shows two washers mounted on the riser rod 130 between the thermal barrier plates 170, 175 to maintain a desired air-break. Similarly, there may be some space between the upper thermal barrier plate 175 and the inside top of the dome.

Alternatively, one or more thermal barriers may be integrally formed as part of an upper portion of the lid 110. Additionally, or as a further alternative, insulating material may be included between one or both thermal barrier plates 170, 175 and the top of the lid 110. The upper thermal barrier plate 175 may be eliminated or replaced with insulation (e.g., ceramic). The insulation may be totally encapsulated between the thermal barrier plate and the inside of the lid 110. A thermal barrier can take many forms.

FIG. 1B shows the lid 110 separated from the lower heat-retaining member 190, in accordance with various embodiments. The lid 110 and the lower heat-retaining member 190 may be separated in this way, particularly during a heat loading phase of preparing the heat-retention cooker for cooking. By separating the lid 110 from the lower heat-retaining member 190, the upper heat-retaining member 150 and the lower heat-retaining member 190 may be heated separately. As shown, the upper heat-retaining member 150 and the lower heat-retaining member 190 may each be placed in contact with or over a heat source 50 configured to transfer relatively high levels of heat to those elements. The heat source 50 may be two stove burners, a camp fire, an electric heating pad specifically designed for high temperatures, an infrared heater that uses infrared light to provide intense, consistent warmth, an induction heater that employs electromagnetic fields to heat metallic objects, a solar concentrator which focuses sunlight onto a specific point using mirrors or lenses for intense heating, an oven or toaster oven set to high temperatures, and a propane torch or butane burner that offers direct flames suitable for achieving high temperatures on the metal plate. Each method varies in efficiency and application, depending on the specific needs and constraints of the situation.

To heat the upper heat-retaining member 150, the riser rod 130 may be lowered to one of its lowest positions, which positions the upper heat-retaining member 150 near the plane of the open lower rim of the lid 110. In this way, the upper heat-retaining member 150 may be placed near or in contact with the heat source 50. In some embodiments the upper heat-retaining member 150 may be configured to be lowered beyond the lower rim of the lid 110. In some embodiments, the upper heat-retaining member 150 may be limited so it cannot be lowered beyond the lower rim of the lid 110. In some embodiments, the upper heat-retaining member 150 may be limited so that in its lowest position it remains bounded by the lid 110 near the lower rim.

The lower heat-retaining member 190 may be heated simply by positioning the lower heat-retaining member 190 on or near its own separate heat source 50.

The heat loading phase may be complete once the upper heat-retaining member 150 and the lower heat-retaining member 190 have reached a desired temperature. As those elements are being heated, a user may measure temperature with a heat sensor to ensure the desired temperature is reached. Once the heat loading phase is complete, the user may reconfigure the lid 110, the upper heat-retaining member 150, and the lower heat-retaining member 190 to start the cooking phase.

FIG. 1C shows the heat-retention cooker 100 reconfigured for the cooking phase, in accordance with various embodiments. In order to prepare for the cooking phase, the user may remove the upper heat-retaining member 150 from the heat supplied by the heat source 50, along with the lid 110. To do so, the user may grab the riser rod 130 by the handle 135 and lift the upper heat-retaining member 150 into an upper position relative to the lid 110. Once in the upper position, the user may secure the riser rod 130 in that upper position using the locking mechanism 140 (e.g., the cotter pin).

In addition, the user may remove lower heat-retaining member 190 from the heat supplied by the heat source (e.g., 50) and place it on a support surface 5. For example, the lower heat-retaining member 190 may be moved away from the heat source or alternatively, the heat source 50 may be shut off, leaving the lower heat-retaining member 190 in-place where it was heated so that turned-off heater acts as a support surface (e.g., 5). With the heat from the heat source removed, the user may place food intended to be cooked on the lower heat-retaining member 190. With the food positioned centrally on the lower heat-retaining member 190 and the upper heat-retaining member 150 secured in an upper position inside the lid 110, the lid 110 may then be seated on the lower heat-retaining member 190 such that the lower rim of the lid 110 engages an upper surface of the lower heat-retaining member 190 and together the lid 110 and the lower heat-retaining member 190 form the cooking chamber 115 there between that contains the food placed on the lower heat-retaining member 190.

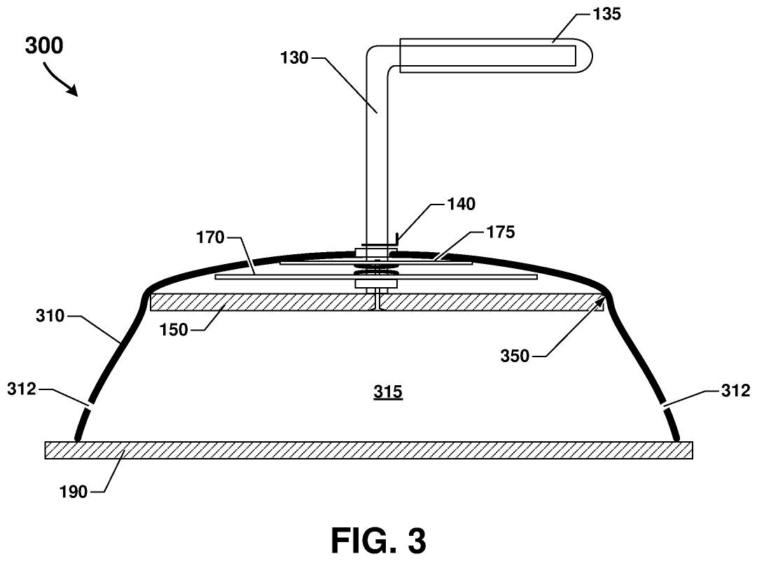

FIG. 2 shows the heat-retention cooker 100 sitting on an alternative lower heat-retaining member 290 in accordance with various embodiments. The alternative lower heat-retaining member 290 may take various forms, including that of a skillet, such as a cast-iron skillet, a pot, or other non-planer member. The alternative lower heat-retaining member 290 may generally have a flat base and shallow sides that may be straight or slightly flared outward. The sides surround and form a cooking well that helps form a large cooking chamber 215 when the lid 110 is placed over the alternative lower heat-retaining member 290. Most pans come with a singular long handle attached to one side, allowing for easy maneuvering on a stovetop. Some pans might also come with a smaller ‘helper’ handle on the opposite side for added support when lifting. The overall shape of both pots and pans is designed to optimize the cooking process by ensuring even heat distribution and easy access to the food being prepared. The alternative lower heat-retaining member 290 may alternatively be formed as a cooking pot, which may have a cylindrical shape with a deep basin, vertical sides, and a flat or slightly rounded bottom. Formed as a cooking pot, the alternative lower heat-retaining member 290 may have one or two handles, which are either short and positioned on opposite sides of the pot or a single longer handle extending from one side.

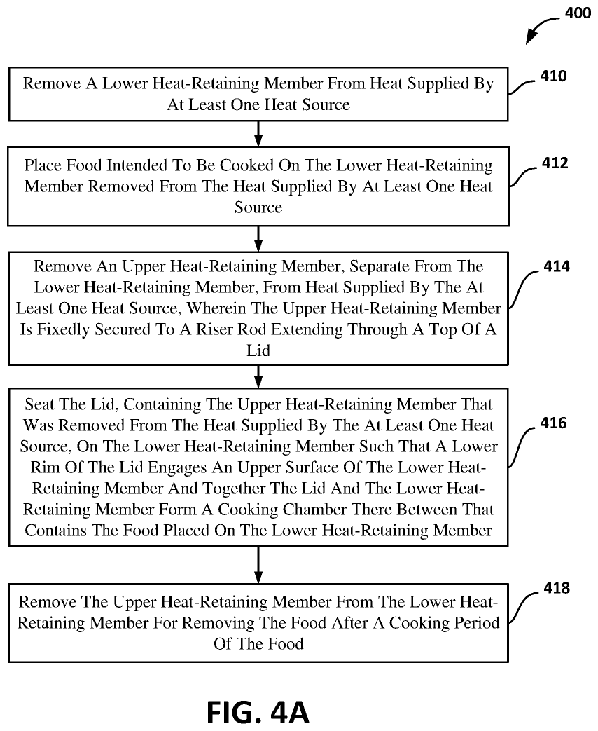

FIG. 3 shows an alternative heat-retention cooker 300 with a contoured lid 310 in accordance with various embodiments. The contoured lid 310 includes an upper region 350 on the inside of the lid that includes a contoured shaped configured to receive the upper heat-retaining member 150 therein when the riser rod 130 is in the higher position.

In various embodiments, the contoured lid 310 may include one or more vent holes 312 that extend through the contoured lid 310 to allow steam out of the cooking chamber 315. When cooking food, such as pizza, it may be desirable to control the amount of steam generated inside the cooking chamber 315. The vent holes 312 may help some of that steam escape. Although the vent holes 312 may allow some airflow out of, or possibly into, the cooking chamber 315, The vent holes 312 may be any shape. Also, the vent holes 312 may be spaced apart from one another, including on opposite sides of the contoured lid 310. In some embodiments, multiple vent holes 312 may be near one another on one side of the contoured lid 310 (e.g., the left side or the right side in the orientation shown in FIG. 3). In some embodiments, the multiple vent holes 312 may only be located on the one side of the contoured lid 310 (e.g., just the left side or just the right side in the orientation shown in FIG. 3). Similar vent holes 312 may be incorporated into the various embodiments of the heat-retention cooker described herein (e.g., 100). Additionally, some embodiments may include flaps or other closing elements that may be included to selectively open or close the vent holes 312.

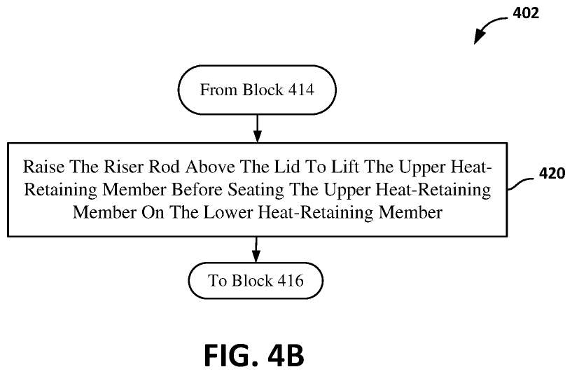

FIGS. 4A-4B are process flow diagrams illustrating example methods 400 and 402 of using a heat-retention cooker in accordance with various embodiments. With reference to FIGS. 4A-4B, the methods 400 and 402 and the operations thereof may be performed using a heat-retention cooker (e.g., 100, 300) configured to cook using retained heat. The operations of the methods 400 and 402 may be controlled by a user or operator.

Referring to FIG. 4A, in the method 400, the user may remove a lower heat-retaining member from heat supplied by at least one heat source in block 410.

In block 412, the user may place food intended to be cooked on the lower heat-retaining member removed from the heat supplied by at least one heat source.

In block 414, the user may remove an upper heat-retaining member, separate from the lower heat-retaining member, from heat supplied by the at least one heat source. The upper heat-retaining member may be fixedly secured to a riser rod extending through a top of a lid.

In block 416, the user may seat the lid, containing the upper heat-retaining member that was removed from the heat supplied by the at least one heat source, on the lower heat-retaining member such that a lower rim of the lid engages an upper surface of the lower heat-retaining member and together the lid and the lower heat-retaining member form a cooking chamber there between that contains the food placed on the lower heat-retaining member.

In block 418, the user may remove the upper heat-retaining member from the lower heat-retaining member for removing the food after a cooking period of the food.

Referring to FIG. 4B, in the method 402, following the operations in block 414, the user may raise the riser rod above the lid to lift the upper heat-retaining member before seating the upper heat-retaining member on the lower heat-retaining member. Following the operations in block 402, the user may proceed to the operations in block 416.

Implementation examples are described in the following paragraphs.

Example 1. A heat-retention cooker that includes a lid configured to sit on top of a lower heat-retaining member that is detached from the lid such that a lower rim of the lid is configured to engage an upper surface of the lower heat-retaining member and together the lid and the lower heat-retaining member are configured to form a cooking chamber there between for containing and cooking food placed on the lower heat-retaining member and under the lid, wherein the lid and the lower heat-retaining member block substantially all airflow into the cooking chamber from under the lid; a riser rod extending through a top of the lid into the cooking chamber, wherein a position of the riser rod relative to the lid is adjustable between at least a lower position and a higher position; and an upper heat-retaining member fixedly secured to the riser rod, wherein movement of the riser rod raises or lowers the upper heat-retaining member.

Example 2. The heat-retention cooker of example 1, further including at least one thermal barrier plate disposed inside the cooking chamber between a top of the lid and the upper heat-retaining member, wherein the riser rod extends through an opening in the at least one thermal barrier plate.

Example 3. The heat-retention cooker of any of examples 1 or 2, wherein the upper heat-retaining member has material characteristics such that, in cooperation with the lower heat-retaining member and the lid, the upper heat-retaining member is configured to retain heat sufficient to maintain the cooking chamber above 400 degrees Fahrenheit for more than 10 minutes after all heat sources heating the upper and lower heat-retaining members have been removed.

Example 4. The heat-retention cooker of any of examples 1-3, in which the lid is a semi-spherical shape.

Example 5. The heat-retention cooker of any of examples 1-4, in which an upper region on the inside of the lid includes a contoured shaped configured to receive the upper heat-retaining member when the riser rod is in the higher position.

Example 6. The heat-retention cooker of any of examples 1-5, further including: a locking mechanism for selectively holding the riser rod in at least one of the lower position, the higher position, or a position there between.

Example 7. The heat-retention cooker of example 6, in which the locking mechanism includes at least one of a cotter pin, a tension spring, a spring-loaded pin latch, or a ball point spring plunger.

Example 8. The heat-retention cooker of example 6, in which the locking mechanism secures the upper heat-retaining member in an upper position in response to the riser rod being raised toward the higher position.

Example 9. The heat-retention cooker of any of examples 1-8, further including: the lower heat-retaining member.

Example 10. A method of using a heat-retention cooker, including: removing a lower heat-retaining member from heat supplied by at least one heat source; placing food intended to be cooked on the lower heat-retaining member removed from the heat supplied by the at least one heat source; removing an upper heat-retaining member, separate from the lower heat-retaining member, from heat supplied by the at least one heat source, in which the upper heat-retaining member is fixedly secured to a riser rod extending through a top of a lid; seating the lid, containing the upper heat-retaining member that was removed from the heat supplied by the at least one heat source, on the lower heat-retaining member such that a lower rim of the lid engages an upper surface of the lower heat-retaining member and together the lid and the lower heat-retaining member form a cooking chamber there between that contains food placed on the lower heat-retaining member; and removing the upper heat-retaining member from the lower heat-retaining member for removing the food after a cooking period of the food.

Example 11. The method of example 10, further including: raising the riser rod above the lid to lift the upper heat-retaining member before seating the upper heat-retaining member on the lower heat-retaining member.

Example 12. The method of any of examples 10 or 11, in which a position of the riser rod relative to the lid is adjustable between at least a lower position and a higher position, in which movement of the riser rod raises or lowers the upper heat-retaining member, in which the heat supplied by the at least one heat source heats the upper heat-retaining member in the lower position.

Example 13. The method of any of examples 10-12, in which the at least one heat source includes at least a first heat source separate from a second heat source, in which the heating of the lower heat-retaining member is done by the first heat source and the heating of the upper heat-retaining member is done by the second heat source.

Example 14. The method of any of examples 10-13, in which the lid and the lower heat-retaining member block substantially all airflow into the cooking chamber from under the lid.

The foregoing descriptions of systems, devices, and methods are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are used to guide the reader through the description of the methods. Further, any reference to claim elements in the singular, for example, using the articles “a,” “an” or “the” is not to be construed as limiting the element to the singular.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A heat-retention cooker, comprising:
a lid configured to sit on top of a lower heat-retaining member that is detached from the lid such that a lower rim of the lid is configured to engage an upper surface of the lower heat-retaining member and together the lid and the lower heat-retaining member are configured to form a cooking chamber there between for containing and cooking food placed on the lower heat-retaining member and under the lid, wherein the lid and the lower heat-retaining member block substantially all airflow into the cooking chamber from under the lid;
a riser rod extending through a top of the lid into the cooking chamber, wherein a position of the riser rod relative to the lid is adjustable between at least a lower position and a higher position; and
an upper heat-retaining member fixedly secured to the riser rod, wherein movement of the riser rod raises or lowers the upper heat-retaining member.

2. The heat-retention cooker of claim 1, further comprising:
at least one thermal barrier plate disposed inside the cooking chamber between a top of the lid and the upper heat-retaining member, wherein the riser rod extends through an opening in the at least one thermal barrier plate.

3. The heat-retention cooker of claim 1, wherein the upper heat-retaining member has material characteristics such that, in cooperation with the lower heat-retaining member and the lid, the upper heat-retaining member is configured to retain heat sufficient to maintain the cooking chamber above 400 degrees Fahrenheit for more than 10 minutes after all heat sources heating the upper and lower heat-retaining members have been removed.

4. The heat-retention cooker of claim 1, wherein the lid is a semi-spherical shape.

5. The heat-retention cooker of claim 1, wherein an upper region on the inside of the lid includes a contoured shaped configured to receive the upper heat-retaining member when the riser rod is in the higher position.

6. The heat-retention cooker of claim 1, further comprising:
a locking mechanism for selectively holding the riser rod in at least one of the lower position, the higher position, or a position there between.

7. The heat-retention cooker of claim 6, wherein the locking mechanism includes at least one of a cotter pin, a tension spring, a spring-loaded pin latch, or a ball point spring plunger.

8. The heat-retention cooker of claim 6, wherein the locking mechanism secures the upper heat-retaining member in an upper position in response to the riser rod being raised toward the higher position.

9. The heat-retention cooker of claim 1, further comprising:
the lower heat-retaining member.

10. A method of using a heat-retention cooker, comprising:
removing a lower heat-retaining member from heat supplied by at least one heat source;
placing food intended to be cooked on the lower heat-retaining member removed from the heat supplied by the at least one heat source;
removing an upper heat-retaining member, separate from the lower heat-retaining member, from heat supplied by the at least one heat source, wherein the upper heat-retaining member is fixedly secured to a riser rod extending through a top of a lid;
seating the lid, containing the upper heat-retaining member that was removed from the heat supplied by the at least one heat source, on the lower heat-retaining member such that a lower rim of the lid engages an upper surface of the lower heat-retaining member and together the lid and the lower heat-retaining member form a cooking chamber there between that contains food placed on the lower heat-retaining member; and
removing the upper heat-retaining member from the lower heat-retaining member for removing the food after a cooking period of the food.

11. The method of claim 10, further comprising:
raising the riser rod above the lid to lift the upper heat-retaining member before seating the upper heat-retaining member on the lower heat-retaining member.

12. The method of claim 10, wherein a position of the riser rod relative to the lid is adjustable between at least a lower position and a higher position, wherein movement of the riser rod raises or lowers the upper heat-retaining member, wherein the heat supplied by the at least one heat source heats the upper heat-retaining member in the lower position.

13. The method of claim 10, wherein the at least one heat source includes at least a first heat source separate from a second heat source, wherein the heating of the lower heat-retaining member is done by the first heat source and the heating of the upper heat-retaining member is done by the second heat source.

14. The method of claim 10, wherein the lid and the lower heat-retaining member block substantially all airflow into the cooking chamber from under the lid.
